(19) United States
(12) Patent Application Publication
(10) Pub. No.: US 2017/0191377 A1
(43) Pub. Date: Jul. 6, 2017

(54) DAMPER AND METHODS OF MAKING AND USING THE SAME

(71) Applicant: BorgWarner Inc., Auburn Hills, MI (US)

(72) Inventor: Christian Longacre, Arden, NC (US)

(21) Appl. No.: 14/987,096

(22) Filed: Jan. 4, 2016

(51) Int. Cl. F01D 25/16; F04D 29/28; F04D 29/056; F16C 27/04; F16C 19/08; F16C 27/06; F16C 33/78; F01D 5/10; F04D 29/053

(52) U.S. Cl. CPC F01D 25/164; F01D 5/10; F04D 29/284; F04D 29/056; F04D 29/053; F16C 19/08; F16C 27/066; F16C 33/782; F16C 27/04; F05D 2220/40; F05D 2240/60; F05D 2260/30; F05D 2260/96

(57) ABSTRACT

A number of variations may include a product including a rotor comprising a shaft having a rotation axis, a bearing at least partially surrounding the shaft allowing for rotation of the shaft within the bearing, and a solid damper at least partially surrounding the bearing wherein the damper is constructed and arranged to restrict axial movement of the bearing.

### TECHNICAL FIELD

The field to which the disclosure generally relates to includes dampers for rotational movement systems including, but not limited to, vehicle components.

### BACKGROUND

In some variations, vehicles may include turbochargers which may include a bearing to support a shaft rotation of a turbine wheel and/or a compressor wheel within a turbocharger housing.

### SUMMARY OF ILLUSTRATIVE VARIATIONS

A number of variations may include a product which may include: a rotor comprising a shaft having a rotation axis, a bearing at least partially surrounding the shaft allowing for rotation of the shaft within the bearing, and a solid damper at least partially surrounding the bearing wherein the damper is constructed and arranged to restrict axial movement of the bearing.

A number of variations may include a method which may include: providing a rotor comprising a shaft having a rotation axis, a bearing at least partially surrounding the shaft allowing for rotation of the shaft within the bearing, and a solid damper at least partially surrounding the bearing wherein the damper is constructed and arranged to restrict axial movement of the bearing; and rotating the shaft within the bearing while restricting movement of the bearing in a axial direction and allowing movement of the bearing in a radial direction.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is an illustration of a product according to a number of variations.

FIG. 2a is a perspective illustration of a product according to a number of variations.

FIG. 2b is a cross-sectional illustration of a product according to a number of variations.

FIG. 3a is a perspective illustration of a product according to a number of variations.

FIG. 3b is a cross-sectional illustration of a product according to a number of variations.

FIG. 4a is a perspective cut-away illustration of a product according to a number of variations.

FIG. 4b1 is a schematic illustration of a product according to a number of variations.

FIG. 4b2 is a schematic illustration of a product according to a number of variations.

FIG. 4b3 is a schematic illustration of a product according to a number of variations.

FIG. 4b4 is a schematic illustration of a product according to a number of variations.

FIG. 4b5 is a schematic illustration of a product according to a number of variations.

FIG. 4b6 is a schematic illustration of a product according to a number of variations.

FIG. 5 is a table of results through use of a product according to a number of variations.

### DETAILED DESCRIPTION OF ILLUSTRATIVE VARIATIONS

The following description of the variations is merely illustrative in nature and is in no way intended to limit the scope of the invention, its application, or uses.

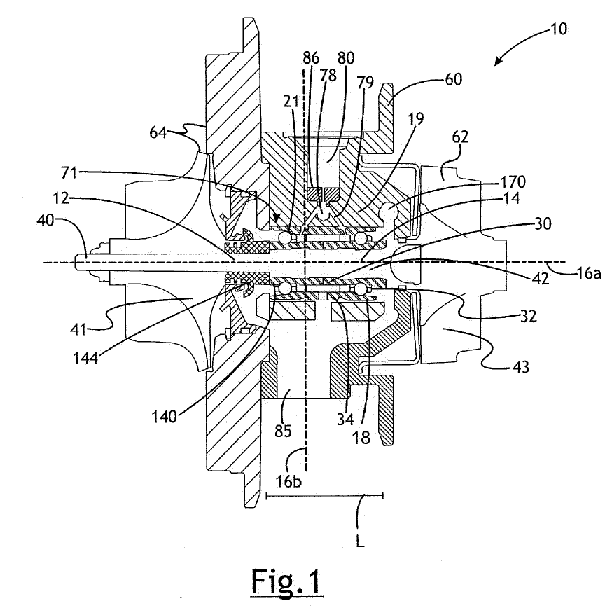

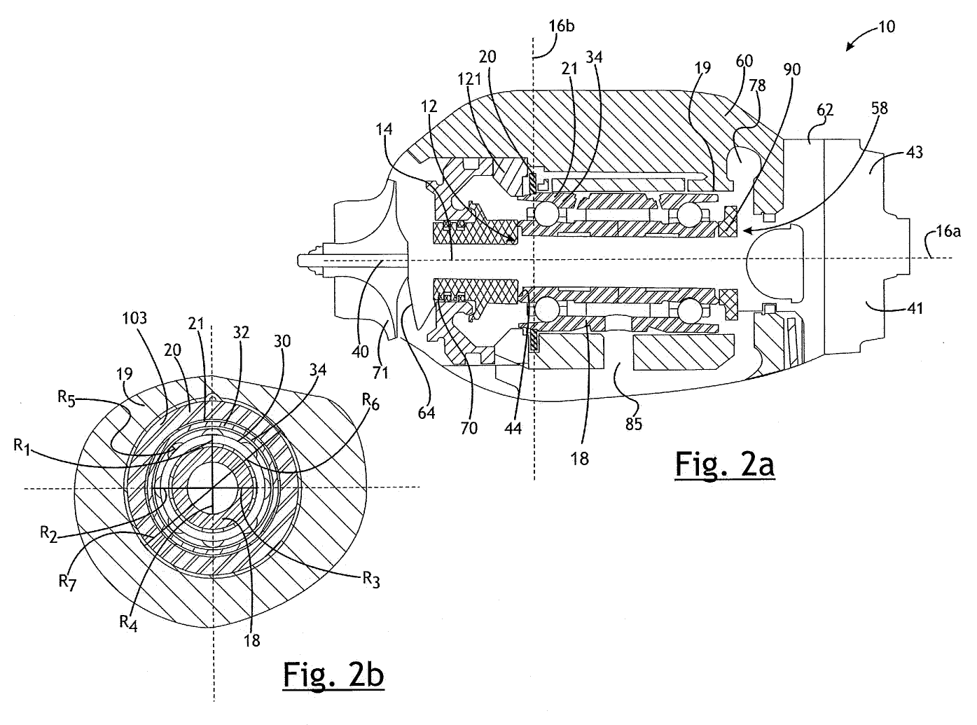

FIGS. 1-2a illustrates a product 10 according to a number of variations. In a number of variations, the product 10 may include a rotor 12. In a number of variations, the rotor 12 may include a shaft 14 having a rotational axis illustrated by line 16a. In a number of variations, the shaft 14 may have a radial axis illustrated by line 16b. In a number of variations, the product 10 may further comprise at least one bearing 18 which may at least partially surround the shaft 14. In a number of variations, the bearing 18 may have a length L. In a number of variations, the product 10 may comprise a turbocharger. In a number of variations, the product 10 may be a turbocharger used in a vehicle. In a number of variations, the vehicle may include a motor vehicle, watercraft, spacecraft, aircraft, or may be another type. In a number of variations, the product 10 may be another device including a rotor including, but not limited to, a gas turbine, a turboprop engine, an auxiliary power unit, a turboshaft engine, a radial turbine, an axial turbine, a radial compressor, an axial compressor, a supercharger, a pump, a drilling rig, a microturbine, a turbine generator, a magnetic turbocharger, a journal bearing turbocharger system, an oil-free turbocharger bearing system, or may be another device. In a number of variations, the shaft 14 may include a compressor end 40. In a number of variations, the compressor end 40 may include a compressor wheel 41 which may rotate along the rotational axis 16a. In a number of variations, the shaft 14 may include a turbine end 42. In a number of variations, the turbine end 42 may include a turbine wheel 43 which may rotate along the rotational axis 16. In a number of variations, the bearing 18 may allow for rotation of the shaft 14 within the bearing 18 along the rotational axis 16a. In a number of variations, the bearing 18 may include a bearing housing 19. In a number of variations, the bearing 18 may be a journal bearing. In a number of variations, the bearing 18 may be a rolling element bearing (REB). In a number of variations, the rolling element bearing 18 may include an inner race 30 (or races), an outer race 34 (or races) and at least one rolling element 32. As shown in FIG. 2b, in a number of variations, the rolling element bearing 18 may have an outer race outer radius R1 and an outer race inner radius R2. In a number of variations, the rolling element bearing 18 may have an inner race outer radius R3 and an inner race inner radius R2. In a number of variations, a rolling element may have a radius R5. In a number of variations, the product 10 may include a damper 20. In a number of variations, the damper 20 may be a solid component. In a number of variations, the damper 20 may at least partially surround the bearing 18. In a number of variations, the damper 20 may contact the bearing 18 along the length of the bearing 18. In a number of variations, the damper 20 may contact the bearing 18 at a plurality of points along the length of the bearing 18. In a number of variations, the damper 20 may be constructed and arranged to restrict, lessen, or eliminate axial movement of the bearing 18 when the shaft 14 is in rotation around the rotational axis 16a. In a number of variations, the damper 20 may be constructed and arranged to restrict, lessen, or eliminate axial movement of the bearing 18 when the shaft 14 is not in rotation around the rotational axis 16a. In a number of variations, the damper 20 may not restrict, lessen, or eliminate radial movement of the bearing 18 or shaft 14 in relation to the radial axis 16b.

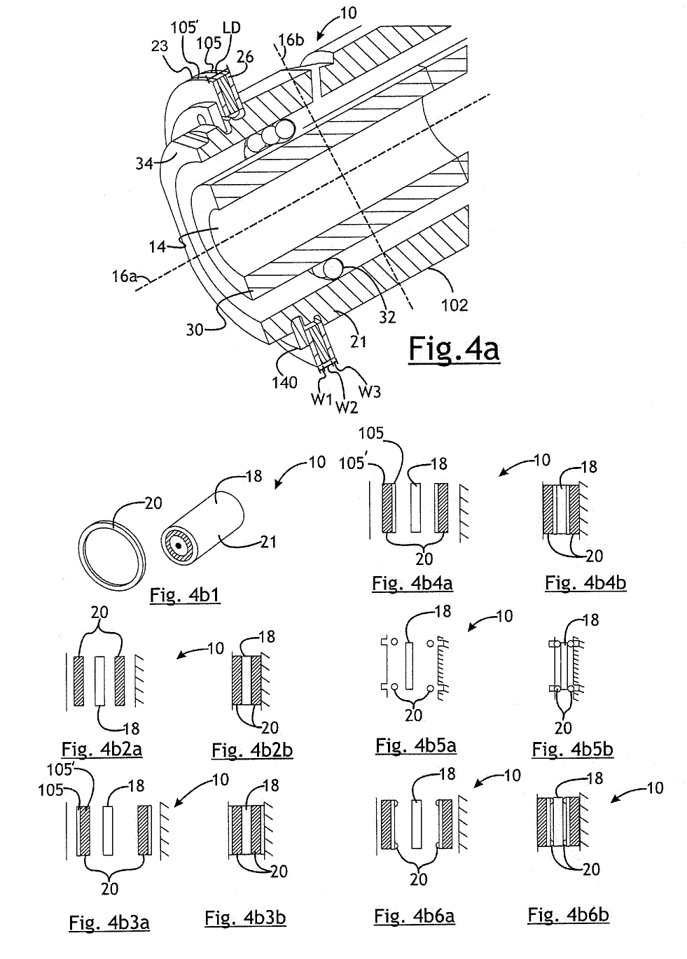

In a number of variations, the damper 20 may be a solid material. In a number of variations, the damper 20 may be a plastic. In a number of variations, the damper 20 may be a metal. In a number of variations, the damper 20 may be a visco-elastic material. In a number of variations, the damper 20 may be an elastomer material. In a number of variations, the damper 20 may be a rubber. In a number of variations, the damper 20 may be a piezoelectric material. In a number of variations, the damper 20 may comprise a material including, but not limited to, plastic steel, stainless steel, copper, nickel, tin, noble metals, zinc, iron, bronze, aluminum, silicon, titanium, platinum, shellac, amber, aramid (including Twaron, Kevlar, Technora, Nomax), silk, leather, rubber, natural rubber, synthetic rubber, silicone rubber, fluoroelastomer rubber, butyl rubber (isobutylene-isoprene), hypalon rubber (chlorosulphonated polyethylene), epichlorohydrin rubber (epichlorohydrin), ethylene propylene diene rubber, fluorocarbon rubber, fluorosilicone rubber, hydrogenated nitrile rubber, nitrile rubber, perfluoroelastomer rubber, polyacrylic rubber, chloroprene rubber, polyurethane rubber, styrene butadiene rubber, acrylonitrile-butadiene rubber, hydrogenated acrylonitrile-butadiene rubber, ethylene acrylic rubber, phenol formaldehyde, polyether urethane, polyester urethane, neoprene, nylon, polyvinyl chloride, polystyrene, polyethylene, polypropylene, polyurethane, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca′, bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, combinations thereof, or may be another type. In a number of variations, the damper 20 may have varying concentrations of any of the materials listed. In a number of variations, the damper 20 may include an o-ring. In a number of variations, the damper 20 may include a cup spring. In a number of variations, the damper 20 may include a metal mesh. In a number of variations, the damper 20 may be applied as a foam spray that hardens in a cavity. In a number of variations, the damper 20 may be layered with different material layers of the materials listed. In a number of variations, the damper 20 may be any size or measurement fit to the desired damping application of the rotor 12 or product 10. In a number of variations, as shown in FIG. 2b and FIG. 4a, the damper 20 may have an outer radius R6 of 2 to 100 mm. In a number of variations, the damper 20 may have an inner radius R7 of 1 to 99 mm. In a number of variations, the damper 20 may have a length LD of 0.1 to 100 mm. In a number of variations, the damper 20 may have a varying outer radius R6 or inner radius R7 along its length LD. In a number of variations, as shown in FIG. 4a, the damper 20 may have a plurality of layers 105, 105′ of varying materials listed in varying concentrations. In a number of variations, as shown in FIG. 4a, the layers 105, 105′ may have varying widths W1, W2, W3 along the length LD of the damper 20. In a number of variations, at least one of W1, W2, or W3 can exist in any proportion such that the length is bounded by the length LD range. In a number of variations, the damper 20 may be layered axially. In a number of variations, the damper 20 may abut a thrust washer 140 to provide axial damping and stiffness in the axial position of the shaft 14. In a number of variations, the damper 20 may be fastened against an REB cartridge 21 sleeve or outer race 34 of the bearing 18 by a retaining ring, or a groove or eclip in the exterior of the REB cartridge 21 sleeve or outer race 34. In a number of variations, this may allow the damper to be assembled in the radial fashion around the exterior of the REB cartridge 21 sleeve or outer race 34. In a number of variations, the damper 20 may only match and affix to the outer race outer radius R1 of the REB cartridge 21 sleeve or outer race 34 at a single point along its length LD. In a number of variations, a spring 23 may accompany the damper 20 as one of its layers 105. In a number of variations, as shown in FIG. 4b, the damper 20 may be orientation of an o-ring, a cup spring, or may contain a single or multiple layers 105. In a number of variations, also shown in FIG. 4b, the bearing 18 may be or include a structural component of the axial damper 20 comprising a steel ring or tube incorporated with or surrounding the bearing 18. In a number of variations, as shown in FIG. 4b, the bearing 18 may be fastened to this structural component by a retaining ring. In a number of variations, as shown in FIG. 4b1, the damper may be a ring surrounding the bearing 18 and/or REB cartridge sleeve 21. In a number of variations, as shown in FIG. 4b2, the damper 20 may include dual portions that surround the bearing 18. In a number of variations, as shown in FIG. 4b3, the damper 20 may include several layers 105, 105′ where layer 105′ may be a plastic and layer 105 may be a metal where the plastic layer 105 contacts the bearing 18. In a number of variations, as shown in FIG. 4b4, the damper 20 may include several layers 105, 105′ where layer 105′ may be a plastic and layer 105 may be a metal where the metal layer 105 contacts the bearing. In a number of variations, as shown in FIG. 4b5, the damper 20 may include o-rings surrounding the bearing 18. In a number of variations, as shown in FIG. 4b6, the damper 20 may include cup springs surrounding the bearing supported by a layer 105, 105′.

In a number of variations, as shown in FIGS. 1, 2a, 2b, 3a, and 3b, the turbocharger 10 may include a turbocharger housing 60. In a number of variations, the turbocharger housing 60 may include a turbine housing 62. In a number of variations, the turbocharger housing 60 may include a compressor housing 64. In a number of variations, the compressor wheel 41 and the turbine wheel 43 may both be solidly affixed to the shaft 14. In a number of variations, both radial and axial dynamic excursions taken by the shaft 14 and the wheels (41, 43) may cause vibrations in the product 10 and can be attributed to a number of factors including, but not limited to, unbalance of the shaft 14, excitation of the turbocharger housing 60, changes in the flow of exhaust gas and air into and out of the turbine and compressor wheels (41, 43), or may be another reason. In a number of variations, the turbocharger may be fed with a first fluid, which may comprise oil, to perform various functions on the bearing 18, shaft 14, and turbocharger 10 including, but not limited to, lubrication of the shaft 14 or the bearing 18, and/or cooling of all components within the turbocharger 10 including, but not limited to, the shaft 14, bearing, 18, or housing 60. In a number of variations, the pressure, temperature, or flowrate of the first fluid may impact the performance of the turbocharger 10. In a number of variations, the first fluid may perform the function of providing a hydrodynamic squeeze film which exerts forces on the shaft 14 or bearing 18. In a number of variations, the first fluid may be fed through oil galleries 78, 79 to the bearing housing 19. In a number of variations, the first fluid may be delivered to rotating shaft 14 and potentially rotating bearing through the oil galleries and exists through an oil drain 85 at the base of the bearing housing 19. In a number of variations, the turbocharger 10 may include a thrust washer 140 and corresponding opposite flinger 144 mounted on the shaft 14.

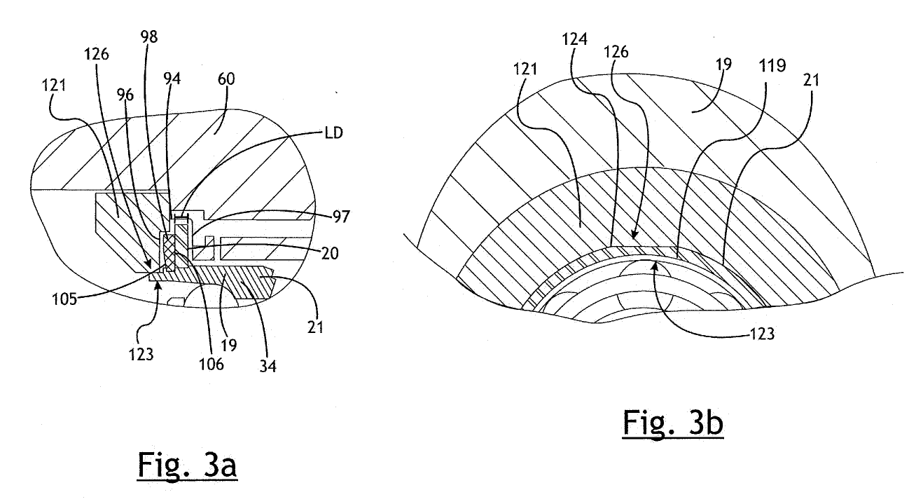

As shown in FIGS. 2a, 2b, 3a and 3b, the bearing 18 may be a rolling element bearing (REB). In a number of variations, the bearing 18 may further include at least one cage, and at least one seal. In a number of variations, the bearing 18 may be pressed or shrunk into a sleeve, i.e. an outer cylindrical housing with oil galleries and locations for the bearing 18, to produce an REB cartridge 21. In a number of variations, the bearing 18 may be pressed onto the shaft 14 and fit loosely within the housing 60 such that the clearance between the bearing 18 and the housing 60 provides for radial movement for the radial squeeze film damper 20. In a number of variations, in a second type of REB, the sleeve may be omitted and a single outer race 34 may be used, with two tracks defined therein. The metal (or ceramic) surrounding the single outer race 34 defines the outer radius of the REB cartridge 21. The outer race 34 and has received therein at least two inner race(s) 30 which may be in contact with the shaft 14 of the turbocharger 10. Unless otherwise indicated, the term “race” shall refer to the metal (or ceramic) element with one or more tracks contacted by the rolling elements, and the term “REB” used herein will encompass both types of REB cartridge 21.

In a number of variations, REBs may have an inner race 30, or races, which may be mounted to the shaft 14. In a number of variations, assembled to the inner race or races 30, may exist a set of rolling elements 32 which may roll in tracks formed in both the inner race and the outer race 34. In a number of variations, the outer race 34 may be mounted within a bore 71 in the bearing housing 19. In a number of variations, since rolling element bearings do not require as much oil as do typical turbocharger journal bearings, an oil restrictor/post 86 may be fitted to the oil inlet 80 to restrict the flow to the REBs. In a number of variations, the bore 71 may be machined with constant diameter where it opens out into an oil flinger cavity 170. In a number of variations, the product may include an anti-rotation ring 121 which may have one or more non-round, e.g., flat sections 124, or shapes for generally providing rotational constraint between the REB cartridge and the anti-rotation ring, fabricated into the otherwise generally round or circular inside surface of the anti-rotation ring 121, such that, when assembled to the REB cartridge 21 or outer race 34, the flat sections 124, in the anti-rotation ring 121, fit to the corresponding flat sections 126, fabricated into the REB cartridge 21 or outer race 34. The term “non-round” refers to any part of the circumference that is not part of a single circle. An arc with the same center but different radius would be “non-round”. An arc with the same radius but a different center would be “non-round” as the term is used herein. Alternatively, the anti-rotation features could be round but simply off-center.

In a number of variations, as shown in FIGS. 2a, 2b, 3a, and 3b, a cylindrical outer surface of the anti-rotation ring 121 discussed above fits to a mating counterbore in the compressor end of the bearing housing 19. In a number of variations, rotation of the anti-rotation ring 121, relative to the bearing housing 19, may be resisted by a pin located in a second bore 119 in the anti-rotation ring and a corresponding third bore 123 in the bearing housing 19. In a number of variations, the rotational constraint due to the pin may provide a unique alignment such that the oil drain in the REB cartridge 21 communicates with an oil drain bore 85 in the bearing housing 19. In a number of variations, to achieve the desired turbocharger 10 aerodynamic performance, the aerodynamics of both turbine and compressor wheels (41, 43) may align with the appropriate aerodynamic features in their respective housings (62, 64).

In a number of variations, the axial alignment of the critical aerodynamic features of both wheels (41, 43), relative to both housings (62, 64), may be controlled by: the position of the REB inner race 30 relative to a ring boss shoulder 58; the axial position of the REB cartridge 21 sleeve or outer race 34 relative to the bearing housing 19, which may be set by the position of damper 20 side faces (105,106) and their positions relative to the mating surfaces (96, 97) on the bearing housing 19 and anti-rotation ring 121.

In a number of variations, the damper 20 may mount to the REB cartridge 21 sleeve or outer race 34, and may be axially constrained by a retaining ring 98 so that, in the axial direction, the damper 20 moves as one with the REB cartridge 21. In a number of variations, when assembled into the turbocharger 10, the faces of the damper 20 may be in close proximity to, albeit separated by a hydraulic film, their mating faces in the bearing housing 19, closure to the bearing housing 19 or anti-rotation ring 121. In a number of variations, the damper 20 may be flat like a washer, but in alternative embodiments of the invention the axially thrusting faces of the damper 20 may be conical or spherical or any other shape to modify the damping characteristics.

In a number of variations, the damper 20 may be located radially on an outer generally cylindrical surface 102 of the REB cartridge 21 sleeve or outer race 34. In a number of variations, the damper 20 may be constrained axially by a retaining ring 98, or a beveled external retaining ring which locates in a groove fabricated into the generally cylindrical outer surface 102 of the REB cartridge 21 sleeve or outer race 34. In a number of variations, the damper 20 may be constrained axially by two retaining rings. In a number of variations, the damper 20 may be a ring with compressor end 40 and turbine end 42, usually flat, axial, or “cheek” faces, assembled such that they may be perpendicular to the shaft 14 rotational axis 16a. In a number of variations, the side facing the turbine end 42 of the damper 20 may be in close proximity to a side facing the compressor end 40 in the bearing housing 19. In a number of variations, with axial thrust from the REB cartridge 21 sleeve or outer race 34 in the direction of the turbine end 42, the turbine-side cheek face 106 of the damper 20 exerts force on the compressor-side face 97 of the bearing housing 19. Similarly with axial thrust from the REB cartridge 21 sleeve or outer race 34 in the direction of the compressor end 40, the compressor-side cheek face 105 of the damper 20 exerts a force on turbine-side face 96 of the anti-rotation ring 121. The pressure generated by this force bears on the turbine-side face 106 of the anti-rotation ring 121.

In a number of variations, as shown in FIGS. 3a and 3b, the cavity for the damper 20 may be defined by the volume enclosed by the REB cartridge 21; the outer counterbore 94 in the bearing housing 19; and the two axially constraining faces (96, 97), which may be co-joined by the outer generally cylindrical surface 103 of the damper 20, in the anti-rotation ring 121 and bearing housing 19. In a number of variations, the configuration of the damper 20 and the relationship between the cheek faces (105,106) and their corresponding reaction faces (96, 97) remain the same, but the interface between the damper 20 and the cavity, in which it resides, may be located at the turbine end 42 of the REB cartridge 21 sleeve or outer race 34. Similarly, the interface between the damper 20 and the cavity, in which it resides, could be located at any axial position along the REB cartridge 21 sleeve or outer race 34. In a number of variations, the damper 20 may be between the axial faces of the thrust washer 140, and flinger 144. In a number of variations, the damper 20 may allow for affixment or retention of the bearing 18 or bearing cartridge 21 in the axial direction.

In a number of variations, to assemble the REB cartridge 21, damper 20, and anti-rotation ring 121, the damper 20 may be assembled to the REB cartridge 21 sleeve or outer race 34 with a snap ring or retaining ring 98; a thermal spacer 90 may be placed on the turbine end 42 of the inner race 30; and the assembly may be slid into the bore 71 in the bearing housing 19. The shaft 14 and wheel 41 may be passed through the thermal spacer 90; through the inner race 30(s), against a tool pressed against the compressor end 40 of the inner race 30. In a number of variations, once the thermal spacer 90 and inner races 30 may be pressed against the piston ring boss shoulder 58 of the shaft 14 and wheel 41, the anti-rotation ring 121 may be assembled to both the anti-rotation feature(s) on the REB cartridge 21 sleeve or outer race 34 and the bearing housing 19. The remainder of the turbocharger 10 may be assembled as normal.

In a number of variations, the damper 20 may be used without the presence of the first fluid. In a number of variations, the damper 20 may damp the product 10 in the axial direction regardless of the changes in first fluid flow rate, temperature, viscosity, and pressure. In a number of variations, this would allow the damping of the product 10 to be uninfluenced by oil flow or viscosity and temperature, fuel exposure, oil exposure or another variable. In a number of variations, the damper 20 may provide a linear stiffness to elastic modulus relationship over the non-linear relationship of an oil film based damper. In a number of variations, the damper 20 may provide axial stiffness, damping, and transfer of thrust load. In a number of variations, the damper 20 may eliminate the risk of air entrapment or cavitation of the first fluid, which may improve noise, vibration, and harshness of the product 10 over time and do so independently of oil flow and temperature. In a number of variations, the damper 20 may allow no axial movement of the REB cartridge 21 sleeve or outer race 34 of the bearing 18.

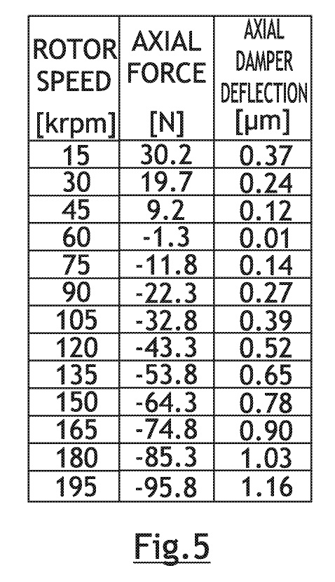

In a number of variations, as shown in FIG. 5, the product 10 may be shown using the damper 20. In a number of variations, the damper 20 may be silicone rubber with an elastic modulus of 0.02 GPa. In a number of variations, the damper 20 may have an axial length (LD) of about 90 microns, an outer radius R6 of about 16 mm, and an inner radius R7 of about 11.5125 mm. As shown, the damper 20 provides minimal axial damper deflection at increased rotor speed and axial load. In a number of variations, as shown in FIG. 5, the small deflection allows the turbocharger 10 aerodynamic clearances to be reduced, increasing the efficiency of the product and/or the compressor or compressor end 40 or turbine or turbine end 42. In a number of variations, FIG. 5 illustrates deflection numbers that are lower in magnitude than deflection allowed by previous designs (30-150 microns).

In a number of variations, a method 800 is shown. In a number of variations, the method 800 may include in block 802 providing a rotor 12 comprising a shaft 14 having a rotation axis 16a, a bearing 18 at least partially surrounding the shaft 14 allowing for rotation of the shaft 14 within the bearing 20, and a solid damper 20 at least partially surrounding the bearing 18 wherein the damper 20 is constructed and arranged to restrict axial movement of the bearing 18. In a number of variations, the method 800 may further include, in block 804, rotating the shaft 14 within the bearing 18 while restricting movement of the bearing 18 in an axial direction and allowing movement of the bearing 18 in a radial direction.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may involve a product that may include a rotor comprising a shaft having a rotation axis, a bearing at least partially surrounding the shaft allowing for rotation of the shaft within the bearing, and a solid damper at least partially surrounding the bearing wherein the damper is constructed and arranged to restrict axial movement of the bearing.

Variation 2 may include the product according to variation 1 wherein the product is a turbocharger and wherein the shaft comprises a compressor end comprising a compressor wheel and a turbine end comprising a turbine wheel.

Variation 3 may include the product according to any of variations 1-2 wherein the bearing comprises a rolling element bearing.

Variation 4 may include the product according to any of variations 1-3 wherein the damper comprising silicone.

Variation 5 may include the product according to any of variations 1-4 wherein the damper comprises a rubber.

Variation 6 may include the product according to any of variations 1-5 wherein the damper does not restrict radial movement of the bearing.

Variation 7 may include the product according to variation 3 wherein the bearing comprises an inner race, an outer race, and a series of rolling elements.

Variation 8 may include the product according to any of variations 1-7 wherein the damper runs the length of the bearing.

Variation 9 may include the product according to any of variations 1-8 wherein the bearing comprises a visco-elastic material.

Variation 10 may include the product according to any of variations 1-9 wherein the bearing comprises an o-ring or a cup-spring.

Variation 11 may include the method that may include providing a rotor comprising a shaft having a rotation axis, a bearing at least partially surrounding the shaft allowing for rotation of the shaft within the bearing, and a solid damper at least partially surrounding the bearing wherein the damper is constructed and arranged to restrict axial movement of the bearing; and rotating the shaft within the bearing while restricting movement of the bearing in a axial direction and allowing movement of the bearing in a radial direction.

Variation 12 may include the method according to variation 11 wherein the product is a turbocharger and wherein the shaft comprises a compressor end comprising a compressor wheel and a turbine end comprising a turbine wheel.

Variation 13 may include the method according to any of variations 11-12 wherein the bearing comprises a rolling element bearing.

Variation 14 may include the method according to any of variations 11-13 wherein the damper comprising silicone.

Variation 15 may include the method according to any of variation 11-14 wherein the damper comprises a rubber.

Variation 16 may include the method according to any of variations 11-15 wherein the damper prevents axial rotation independent of the presence of a fluid.

Variation 17 may include the method according to variation 13 wherein the bearing comprises an inner race, an outer race, and a series of rolling elements.

Variation 18 may include the method according to any of variations 11-17 wherein the damper runs the length of the bearing.

Variation 19 may include the method according to any of variations 11-18 wherein the bearing comprises a visco-elastic material.

Variation 20 may include the method according to any of variations 11-19 wherein the bearing comprises an o-ring or a cup-spring.

The above description of select variations within the scope of the invention is merely illustrative in nature and, thus, variations or variants thereof are not to be regarded as a departure from the spirit and scope of the invention.

What is claimed is:

1. A product comprising:
a rotor comprising a shaft having a rotation axis, a bearing at least partially surrounding the shaft allowing for rotation of the shaft within the bearing, and a solid damper at least partially surrounding the bearing wherein the damper is constructed and arranged to restrict axial movement of the bearing wherein the damper axially comprises a plurality of layers comprising at least one plastic layer and at least one metal layer.

2. The product as set forth in claim 1 wherein the product is a turbocharger and wherein the shaft comprises a compressor end comprising a compressor wheel and a turbine end comprising a turbine wheel.

3. The product as set forth in claim 1 wherein the bearing comprises a rolling element bearing.

4. The product as set forth in claim 1 wherein at least one of the layers of the damper comprises silicone.

5. The product as set forth in claim 1 wherein at least one of the layers of the damper comprises a rubber.

6. The product as set forth in claim 1 wherein the damper does not restrict radial movement of the bearing.

7. The product as set forth in claim 3 wherein the bearing comprises an inner race, an outer race, and a series of rolling elements.

8. The product of claim 1 wherein the damper runs the length of the bearing.

9. The product of claim 1 wherein the bearing comprises a visco-elastic material.

10. The product of claim 1 wherein the bearing comprises an o-ring or a cup-spring.

11. A method comprising:
providing a rotor comprising a shaft having a rotation axis, a bearing at least partially surrounding the shaft allowing for rotation of the shaft within the bearing, and a solid damper at least partially surrounding the bearing wherein the damper is constructed and arranged to restrict axial movement of the bearing; and
rotating the shaft within the bearing while restricting movement of the bearing in an axial direction and allowing movement of the bearing in a radial direction wherein the damper axially comprises a plurality of layers comprising at least one plastic layer and at least one metal layer.

12. The method as set forth in claim 11 wherein the shaft comprises a compressor end comprising a compressor wheel and a turbine end comprising a turbine wheel.

13. The method as set forth in claim 11 wherein the bearing comprises a rolling element bearing.

14. The method as set forth in claim 11 wherein at least one of the layers of the damper comprises silicone.

15. The method as set forth in claim 11 wherein at least one of the layers of the damper comprises a rubber.

16. The method as set forth in claim 11 wherein the damper prevents axial rotation independent of the presence of a fluid.

17. The method as set forth in claim 13 wherein the bearing comprises an inner race, an outer race, and a series of rolling elements.

18. The method of claim 11 wherein the damper runs the length of the bearing.

19. The method of claim 11 wherein the bearing comprises a visco-elastic material.

20. The method of claim 11 wherein the bearing comprises an o-ring or a cup-spring.

21. The product of claim 1 wherein the damper comprises silicone rubber.

22. The product of claim 1 wherein the damper comprises at least one of carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), or metallic alloys of plastic steel, stainless steel, copper, nickel, tin, noble metals, zinc, iron, bronze, aluminum, silicon, titanium, or platinum.

23. The product of claim 1 wherein the damper comprises at least one of fluoroelastomer rubber, butyl rubber, hypalon rubber, epichlorohydrin rubber, ethylene propylene diene rubber, fluorocarbon rubber, fluorosilicone rubber, hydrogenated nitrile rubber, nitrite rubber, perfluoroelastomer rubber, polyacrylic rubber, chloroprene rubber, polyurethane rubber, styrene butadiene rubber, acrylonitrile-butadiene rubber, hydrogenated acrylonitrile-butadiene rubber, ethylene acrylic rubber, phenol formaldehyde, polyether urethane, polyester urethane, neoprene, nylon, polyvinyl chloride, polystyrene, polyethylene, polypropylene, polyurethane, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, or PEEK.

24. The product of claim 21 wherein the damper has an elastic modulus of 0.02 GPa.

25. The product of claim 1 wherein the damper damps the product in the axial direction regardless of the changes in first fluid flow rate, temperature, viscosity, and pressure.

26. The product of claim 21 wherein the damper has an axial length of about 90 microns, an outer radius of about 16 mm, and an inner radius of about 11.5125 mm.
